(19) United States
(12) Patent Application Publication
(10) Pub. No.: US 2024/0284977 A1
(43) Pub. Date: Aug. 29, 2024

(54) AEROSOL-GENERATING DEVICE WITH AUTOMATIC DISCONNECTION

(71) Applicant: Philip Morris Products S.A., Neuchatel (CH)

(72) Inventors: Rui Nuno Rodrigues Alves BATISTA, Neuchatel (CH); Alexandra SEREDA, Neuchatel (CH)

(73) Assignee: Philip Morris Products S.A., Neuchatel (CH)

(21) Appl. No.: 18/573,189

(22) PCT Filed: Jun. 27, 2022
(86) PCT No.: PCT/EP2022/067519

§ 371 Date: Dec. 21, 2023

(30) Foreign Application Priority Data
Jun. 29, 2021 (EP) 21182411.5

(51) Int. Cl. A24F 40/46; A24F 40/10; A24F 40/42; A24F 40/44; A24F 40/57

(52) U.S. Cl. CPC A24F 40/46; A24F 40/10; A24F 40/42; A24F 40/44; A24F 40/57

(57) ABSTRACT

A heating assembly for an aerosol-generating device is provided, the heating assembly including: a first solder spot; a second solder spot; and a connection strip electrically connecting the first solder spot with the second solder spot, one of the first solder spot and the second solder spot being configured as a soft solder spot with a melting temperature between 225° C. and 275° C., and the connection strip being configured as a bimetal strip.

The present invention relates to a heating assembly for an aerosol-generating device. The present invention further relates to an aerosol-generating device comprising the heating assembly.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided in liquid form. The aerosol-forming substrate may be volatilized in a heating chamber of the aerosol-generating device. A heating assembly comprising a heating element may be arranged in or around the heating chamber for heating the aerosol-forming substrate.

The heating element may be configured as a resistive heating element. The heating element may be arranged adjacent a wicking element configured for wicking the aerosol-forming substrate towards the heating element from a liquid reservoir. If the liquid reservoir is depleted, no more aerosol-forming substrate is wicked towards the heating element. If the heating element is nonetheless operated when no a liquid substrate is present in the wick anymore, overheating may become a problem. Overheating of the wicking material may lead to the release of undesired vapors.

It would be desirable to have a heating assembly for an aerosol-generating device with overheating prevention. It would be desirable to have a heating assembly for an aerosol-generating device in which the release of undesired vapors due to overheating is prevented. It would be desirable to have a heating assembly for an aerosol-generating device with improved safety. It would be desirable to have a heating assembly for an aerosol-generating device with mechanical overheating prevention. It would be desirable to have a heating assembly for an aerosol-generating device with automatic overheating prevention.

According to an embodiment of the invention there is provided a heating assembly for an aerosol-generating device. The heating assembly may comprise a first solder spot and a second solder spot. The heating assembly may further comprise a connection strip electrically connecting the first solder spot with the second solder spot. One of the first solder spot and the second solder spot may be configured as a soft solder spot with a melting temperature between 200° C. and 300° C. The connection strip may be configured as a bimetal strip.

According to an embodiment of the invention there is provided a heating assembly for an aerosol-generating device. The heating assembly comprises a first solder spot and a second solder spot. The heating assembly further comprises a connection strip electrically connecting the first solder spot with the second solder spot. One of the first solder spot and the second solder spot is configured as a soft solder spot with a melting temperature between 200° C. and 300° C. The connection strip is configured as a bimetal strip.

The heating assembly according to the present invention has an automatic protection against overheating. In case of overheating, the soft solder spot will synergistically act together with the bimetal strip to disconnect the heating assembly. More specifically, if the operating temperature of the heating assembly exceeds a desired temperature, the soft solder spot will melt. The melting of the soft solder spot will lead to the connection strip, connecting the soft solder spot, being released from the soft solder spot. At the same time, the connection strip being configured as a bimetal strip will bend away from the soft solder spot due to the temperature increase. The melting of the soft solder spot together with the bending away action of the connection strip will lead to an electrical disconnection. The electrical disconnection will disable the function of the heating assembly and thereby create an automatic overheating prevention.

The term “soft solder spot” refers to a solder spot having a relatively low melting temperature, exemplarily a melting temperature of below 300° C.

The melting temperature of the soft solder spot may be between 225° C. and 275° C., preferably around 250°.

This melting temperature is optimized to prevent an overheating of the heating assembly. This temperature may be slightly higher than the operating temperature of the heating assembly. The soft solder spot may have a melting temperature higher than the operating temperature of the heating assembly.

The connection strip may be arranged freely spanning between the first solder spot and the second solder spot.

The spanning arrangement of the connection strip may enable a bending away action of the connection strip in case the temperature exceeds the operating temperature of the heating assembly. As described herein, the soft solder spot may in this case melt and thereby release the part of the connection strip connected to the soft solder spot. At the same time, the connection strip bents away from the soft solder spot due to the bimetal material of the connection strip. Due to the spanning arrangement of the connection strip, the connection strip can then bend away from the soft solder spot thereby electrically disconnecting from the soft solder spot. The connection strip may then be only connected to the other solder spot, which is not configured as a soft solder spot. This other solder spot may act as a hinge around which the connection strip rotates during the disconnection action.

The connection strip may be configured to disconnect from the soft solder spot by bending away from the soft solder spot when the temperature of the connection strip exceeds 300° C., preferably when the temperature of the connection strip exceeds 275° C., most preferably when the temperature of the connection strip exceeds 250° C.

The melting temperature of the other solder spot, not being the soft solder spot, may be between 600° C. and 900° C., preferably between 650° C. and 850° C., most preferably between 700° C. and 800° C.

This solder spot is configured to not melt during an overheating scenario. This solder spot is not melting, and the connection strip is securely bending away thereby facilitating an electrical disconnection action. The connection strip is securely held by the solder spot not being configured as the soft solder spot even in case of an overheating scenario.

The bimetal strip may comprise an active layer and a passive layer.

The active layer may have a higher coefficient of thermal expansion than the passive layer. The active layer may face the heating assembly. The passive layer may face away from the heating assembly.

The bimetal strip may comprise a layer of an alloy of Fe—Ni and a layer of one of Cu, Ni, Fe—Ni—Cr, Fe—Ni—Mn, and Mn—Ni—Cu.

The bimetal strip may be configured to not change its shape during a normal operating temperature of the heating assembly.

Consequently, no mechanical stress is induced between the first and second solder spot during a normal operating temperature.

The normal operating temperature of the heating assembly may be between 90° C. and 250° C., preferably between 150° C. and 245° C., most preferably between 200° C. and 240° C.

The soft solder spot may comprise one of Sn95Pb5, Pb, Pb75In25 and Pb68Sn32.

The soft solder spot may consist of one of Sn95Pb5, Pb, Pb75In25 and Pb68Sn32.

The other solder spot, not being the soft solder spot, may comprise silver, preferably may consist of silver.

The soft solder spot may be configured to melt and release the connection strip when the temperature of the soft solder spot exceeds 300° C., preferably when the temperature of the soft solder spot exceeds 275° C., most preferably when the temperature of the soft solder spot exceeds 250° C.

The heating assembly may further comprise a third solder spot and a heating filament arranged electrically connected between the third solder spot and one of the first solder spot of the second solder spot.

The heating action of the heating assembly may be realized by the heating element. The electrical connection of the heating assembly may be a connection in series between the heating element and the connection strip. The heating assembly may comprise a first contact and a second contact. The first and second contacts may be configured to supply electrical energy to the heating assembly from a power supply of the aerosol-generating device. The first contact may be electrically connected to the third solder spot. The third solder spot may be configured as the first contact. The second contact may be electrically connected with one of the first solder spot and the second solder spot. This solder spot may be configured as the second contact. The other of the first solder spot and the second solder spot may be electrically arranged between the third solder spot and the solder spot connected with the second contact. Electrical energy may be supplied through the heating assembly via the first contact, followed by the third solder spot, followed by the heating filament, followed by one of the first solder spot and the second solder spot, followed by the connection strip, followed by the other of the first solder spot and the second solder spot and finally through the second contact.

The heating element may be arranged electrically connecting the third solder spot and one of the first and second solder spot. The heating element may be in direct contact with the wicking element. The heating element may be printed onto the wicking element. The heating element may be embedded in the wicking element. The heating element may be a single filament. The heating element may have a S-shape.

The invention further relates to an aerosol-generating device comprising a heating assembly as described herein.

The aerosol-generating device may further comprise a liquid reservoir comprising liquid aerosol-forming substrate and a wicking element configured for wicking the liquid aerosol-forming substrate from the liquid reservoir to the heating assembly.

The heating filament of the heating assembly may be configured to heat and vaporize the liquid aerosol-forming substrate.

One or more of the first solder spot may be soldered, preferably by means of a first electrical contact pad, onto the wicking element, the second solder spot may be soldered, preferably by means of a second electrical contact pad, onto the wicking element, and the third solder spot may be soldered, preferably by means of a third electrical contact pad, onto the wicking element. The first electrical contact pad may be configured as the first contact. The second electrical contact pad may be configured as the second contact.

The wicking element may be elongate. The wicking element may be plate-shaped. The wicking element may be rectangular. One or both of the heating filament and the connection strip may be arranged parallel to the wicking element. One or more of the first, the second and the third solder spots may be arranged on the wicking element. One or more of the first, the second and the third solder spots may be arranged on the wicking element via electrical contact pads. The first solder spot may be arranged on the wicking element via a first electrical contact pad. The second solder spot may be arranged on the wicking element via a second electrical contact pad. The third solder spot may be arranged on the wicking element via a third electrical contact pad.

The aerosol-generating device may further comprise a power supply for powering the heater assembly and a controller for controlling the supply of electrical energy from the power supply to the heater assembly.

The aerosol-generating device may comprise electric circuitry. The electric circuitry may comprise a microprocessor, which may be a programmable microprocessor. The microprocessor may be part of the controller. The electric circuitry may comprise further electronic components. The electric circuitry may be configured to regulate a supply of power to the heating element. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

The aerosol-generating device may comprise the power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The power supply may be electrically connected to the third solder spot. The power supply may be electrically connected to one of the first solder spot and the second solder spot.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article or smoking article.

The aerosol-forming substrate may be provided in a liquid form. The liquid aerosol-forming substrate may comprise additives and ingredients, such as flavourants. The liquid aerosol-forming substrate may comprise water, solvents, ethanol, plant extracts and natural or artificial flavours. The liquid aerosol-forming substrate may comprise nicotine. The liquid aerosol-forming substrate may have a nicotine concentration of between about 0.5% and about 10%, for example about 2%. The liquid aerosol-forming substrate may be contained in the liquid storage portion of the aerosol-generating article, in which case the aerosol-generating article may be denoted as a cartridge.

The wicking element may have a fibrous or spongy structure. The wicking element preferably comprises a bundle of capillaries. For example, the wicking element may comprise a plurality of fibres or threads or other fine bore tubes. The fibres or threads may be generally aligned to convey liquid to the heater. Alternatively, the wicking element may comprise sponge-like or foam-like material. The structure of the wicking element forms a plurality of small bores or tubes, through which the liquid can be transported by capillary action. The wicking element may comprise any suitable material or combination of materials. Examples of suitable materials are a sponge or foam material, ceramic- or graphite-based materials in the form of fibres or sintered powders, foamed metal or plastics materials, a fibrous material, for example made of spun or extruded fibres, such as cellulose acetate, polyester, or bonded polyolefin, polyethylene, ethylene or polypropylene fibres, nylon fibres or ceramic. Ceramic is a particularly preferred material for the wicking element. The wicking element is preferably a porous wicking element. The wicking element may have any suitable capillarity and porosity so as to be used with different liquid physical properties. The liquid has physical properties, including but not limited to viscosity, surface tension, density, thermal conductivity, boiling point and vapour pressure, which allow the liquid to be transported through the wicking element by capillary action. The wicking element may be configured to convey the aerosol-forming substrate to the heating element. The wicking element may extend into interstices in the heating element.

The liquid storage portion may be any suitable shape and size. For example, the liquid storage portion may be substantially cylindrical. The cross-section of the liquid storage portion may, for example, be substantially circular, elliptical, square or rectangular.

The liquid storage portion may comprise a housing. The housing may comprise a base and one or more sidewalls extending from the base. The base and the one or more sidewalls may be integrally formed. The base and one or more sidewalls may be distinct elements that are attached or secured to each other. The housing may be a rigid housing. As used herein, the term ‘rigid housing’ is used to mean a housing that is self-supporting. The rigid housing of the liquid storage portion may provide mechanical support to the aerosol-generating means.

The liquid storage portion may comprise one or more flexible walls. The flexible walls may be configured to adapt to the volume of the liquid aerosol-forming substrate stored in the liquid storage portion. The housing of the liquid storage portion may comprise any suitable material. The liquid storage portion may comprise substantially fluid impermeable material. The housing of the liquid storage portion may comprise a transparent or a translucent portion, such that liquid aerosol-forming substrate stored in the liquid storage portion may be visible to a user through the housing. The liquid storage portion may be configured such that aerosol-forming substrate stored in the liquid storage portion is protected from ambient air. The liquid storage portion may be configured such that aerosol-forming substrate stored in the liquid storage portion is protected from light. This may reduce the risk of degradation of the substrate and may maintain a high level of hygiene.

The liquid storage portion may be substantially sealed. The liquid storage portion may comprise one or more outlets for liquid aerosol-forming substrate stored in the liquid storage portion to flow from the liquid storage portion to the aerosol-generating device. The liquid storage portion may comprise one or more semi-open inlets. This may enable ambient air to enter the liquid storage portion. The one or more semi-open inlets may be semi-permeable membranes or one-way valves, permeable to allow ambient air into the liquid storage portion and impermeable to substantially prevent air and liquid inside the liquid storage portion from leaving the liquid storage portion. The one or more semi-open inlets may enable air to pass into the liquid storage portion under specific conditions. The liquid storage portion may be arranged permanently in the main body of the aerosol-generating device. The liquid storage portion may be refillable. Alternatively, the liquid storage portion may be configured as a replaceable liquid storage portion. The liquid storage portion may be part of or configured as a replaceable cartridge. The aerosol-generating device may be configured for receiving the cartridge. A new cartridge may be attached to the aerosol-generating device when the initial cartridge is spent.

Preferably, the wicking element is in fluid communication with the liquid storage portion so as to wick liquid aerosol-forming substrate from the liquid storage portion. The wicking element is preferably configured to wick the liquid aerosol-forming substrate from the liquid storage portion to the heating element.

A wall of the housing of the aerosol-generating device may be provided with at least one air inlet. The air inlet may be a semi-open inlet. The semi-open inlet may be an inlet which permits air or fluid flow in one direction, such as into the device, but at least restricts, preferably prohibits, air or fluid flow in the opposite direction. The semi-open inlet preferably allows ambient air to enter the aerosol-generating device. Air or liquid may be prevented from leaving the aerosol-generating device through the semi-open inlet. The semi-open inlet may for example be a semi-permeable membrane, permeable in one direction only for air, but is air- and liquid-tight in the opposite direction. The semi-open inlet may for example also be a one-way valve. Preferably, the semi-open inlets allow air to pass through the inlet only if specific conditions are met, for example a minimum depression in the aerosol-generating device or a volume of air passing through the valve or membrane.

In any of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal® and iron-manganese-aluminium based alloys.

In composite materials, the electrically resistive material may optionally be embedded in, encapsulated or coated with an insulating material or vice-versa, depending on the kinetics of energy transfer and the external physicochemical properties required.

The heating element is preferably configured as a resistive heater that is arranged between the third solder spot and one of the first solder spot and the second solder spot. The resistive heater is arranged adjacent and preferably parallel to the wicking element.

Alternatively, the heating element may exemplarily be a capillary tube heater, a mesh heater or a metal plate heater. The heating element may comprise a flat heater with for example a solid or mesh surface. The heating element may comprise an arrangement of filaments. The heating element may be arranged in direct contact with a proximal surface of the wicking element.

Below, there is provided a non-exhaustive list of non-limiting examples. Any one or more of the features of these examples may be combined with any one or more features of another example, embodiment, or aspect described herein.

Example A: A heating assembly for an aerosol-generating device comprising:
a first solder spot;
a second solder spot;
a connection strip electrically connecting the first solder spot with the second solder spot,
wherein one of the first solder spot and the second solder spot is configured as a soft solder spot with a melting temperature between 200° C. and 300° C., and wherein the connection strip is configured as a bimetal strip.

Example B: The heating assembly according to example A, wherein the melting temperature of the soft solder spot is between 225° C. and 275° C., preferably around 250°.

Example C: The heating assembly according to any of the preceding examples, wherein the connection strip is arranged freely spanning between the first solder spot and the second solder spot.

Example D: The heating assembly according to any of the preceding examples, wherein the connection strip is configured to disconnect from the soft solder spot by bending away from the soft solder spot when the temperature of the connection strip exceeds 300° C., preferably when the temperature of the connection strip exceeds 275° C., most preferably when the temperature of the connection strip exceeds 250° C.

Example E: The heating assembly according to any of the preceding examples, wherein the melting temperature of the other solder spot, not being the soft solder spot, is between 600° C. and 900° C., preferably between 650° C. and 850° C., most preferably between 700° C. and 800° C.

Example F: The heating assembly according to any of the preceding examples, wherein the bimetal strip comprises an active layer and a passive layer.

Example G: The heating assembly according to any of the preceding examples, wherein the bimetal strip comprises a layer of an alloy of Fe—Ni and a layer of one of Cu, Ni, Fe—Ni—Cr, Fe—Ni—Mn, and Mn—Ni—Cu.

Example H: The heating assembly according to any of the preceding examples, wherein the bimetal strip is configured to not change its shape during a normal operating temperature of the heating assembly.

Example I: The heating assembly according to any of the preceding examples, wherein the normal operating temperature of the heating assembly is between 90° C. and 250° C., preferably between 150° C. and 245° C., most preferably between 200° C. and 240° C.

Example J: The heating assembly according to any of the preceding examples, wherein the soft solder spot comprises one of Sn95Pb5, Pb, Pb75In25 and Pb68Sn32. Example K: The heating assembly according to any of the preceding examples, wherein the soft solder spot consists of one of Sn95Pb5, Pb, Pb75In25 and Pb68Sn32.

The heating assembly according to any of the preceding examples, wherein the other solder spot, not being the soft solder spot, comprises silver, preferably consists of silver.

Example L: The heating assembly according to any of the preceding examples, wherein the soft solder spot is configured to melt and release the connection strip when the temperature of the soft solder spot exceeds 300° C., preferably when the temperature of the soft solder spot exceeds 275° C., most preferably when the temperature of the soft solder spot exceeds 250° C.

Example M: The heating assembly according to any of the preceding examples, further comprising a third solder spot and a heating filament arranged electrically connected between the third solder spot and one of the first solder spot of the second solder spot.

Example N: An aerosol-generating device comprising a heating assembly according to any of the preceding examples.

Example O: The aerosol-generating device of example N, further comprising a liquid reservoir comprising liquid aerosol-forming substrate and a wicking element configured for wicking the liquid aerosol-forming substrate from the liquid reservoir to the heating assembly.

Example P: The aerosol-generating device of example O, wherein one or more of the first solder spot is soldered, preferably by means of a first electrical contact pad, onto the wicking element, the second solder spot is soldered, preferably by means of a second electrical contact pad, onto the wicking element, and the third solder spot is soldered, preferably by means of a third electrical contact pad, onto the wicking element.

Example Q: The aerosol-generating device of one of examples N to P, further comprising a power supply for powering the heater assembly and a controller for controlling the supply of electrical energy from the power supply to the heater assembly.

Example R: The aerosol-generating device of example Q, wherein the power supply is electrically connected to the third solder spot, and wherein the power supply is electrically connected to one of the first solder spot and the second solder spot.

Features described in relation to one embodiment may equally be applied to other embodiments of the invention.

The invention will be further described, by way of example only, with reference to the accompanying drawings in which:

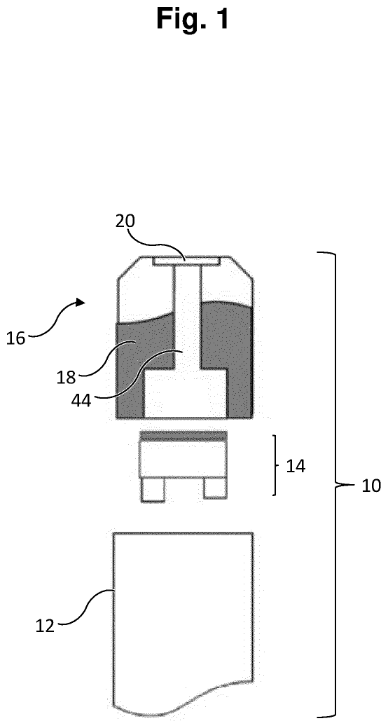

FIG. 1 shows an aerosol-generating device utilizing a heating assembly; and

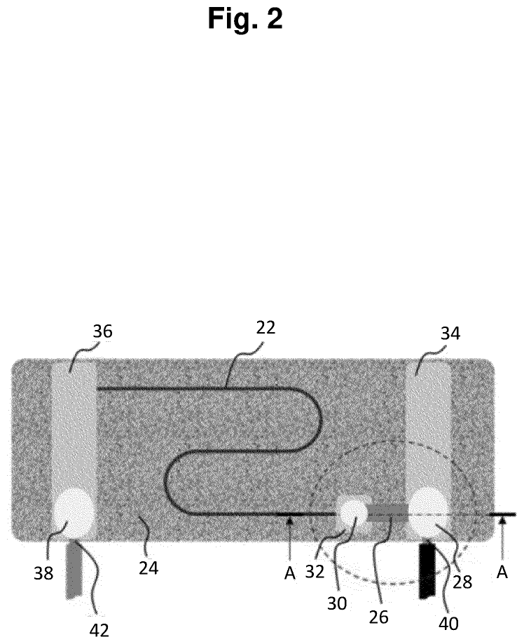

FIG. 2 shows the heating assembly; and

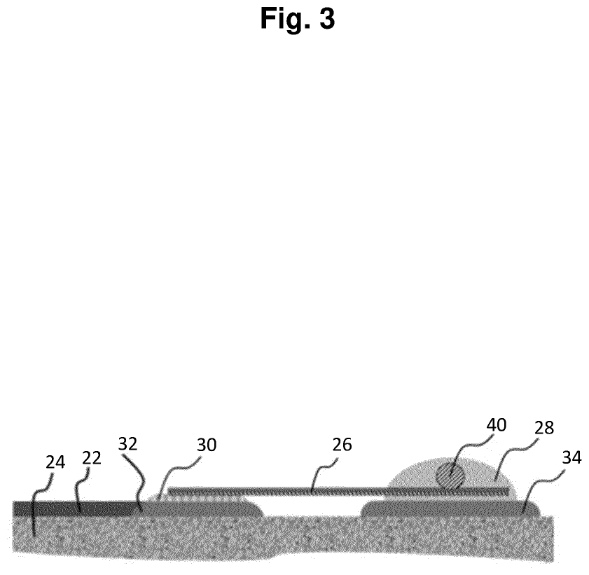

FIG. 3 shows a sectional view of the heating assembly; and

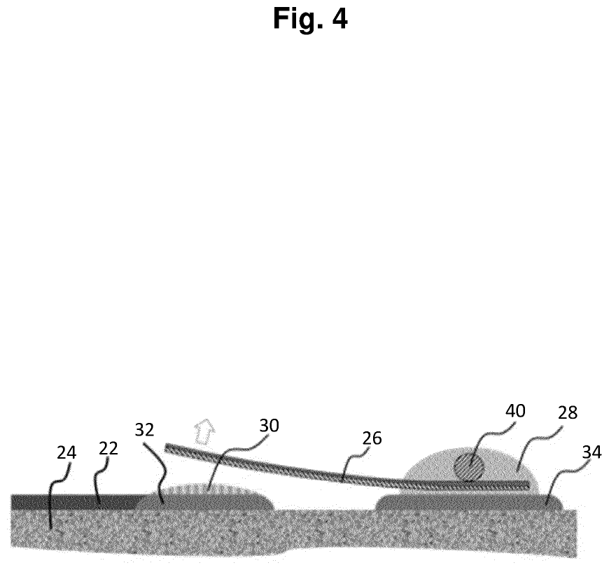

FIG. 4 shows a sectional view of the heating assembly in an overheating scenario.

FIG. 1 shows an aerosol-generating device 10. The aerosol-generating device 10 comprises a main body 12. Within the main body 12, a power supply in the form of a battery (not shown) is arranged. Additionally, electrical circuitry (not shown) is arranged in the main body 12. The electrical circuitry is configured for controlling the supply of electrical energy from the power supply to a heating assembly 14.

FIG. 1 further shows a cartridge 16. The cartridge 16 comprises a liquid storage portion 18 for holding liquid aerosol-forming substrate. The liquid aerosol-forming substrate is wicked towards the heating assembly 14. The wicking action of the liquid aerosol-forming substrate is preferably facilitated by a wicking element 24 as shown in more detail in the below discussed FIGS. 2 to 4. The heating assembly 14 is sandwiched between the main body 12 and the cartridge 16. When the cartridge 16 is attached to the main body 12, the heating assembly 14 is securely held between the cartridge 16 and the main body 12. Alternatively, the heating assembly 14 may be fixed to the cartridge 16 or to the main body 12. The cartridge 16 is replaceable or refillable. The cartridge 16 further comprises a mouthpiece 20 through which the aerosol generated by the aerosol-generating device 10 can exit the device and be inhaled by a user.

Fluidly connecting the heating assembly 14 with the mouthpiece 20, an airflow channel 44 is arranged. The aerosol-forming substrate that is vaporized by the heating assembly 14 can travel through the airflow channel 44 towards the mouthpiece 20. The aerosol may be formed at the heating assembly 14 or downstream of the heating assembly 14 in the airflow channel 44.

Ambient air may be drawn into the aerosol-generating device 10 and towards the heating assembly 14 through an air inlet (not shown). The air inlet may be arranged in the main body 12 or in the cartridge 16. The air inlet is fluidly connected with the heating assembly 14.

FIG. 2 shows the heating assembly 14 in more detail. The heating assembly 14 comprises a heating element 22. The heating element 22 is configured as an electrically resistive filament. The electrically resistive filament is printed onto or embedded into the wicking element 24. The heating element 22 is configured to be resistively heated to vaporize the liquid aerosol-forming substrate. The liquid aerosol-forming substrate to be vaporized is provided in the wicking element 24.

The wicking element 24 has a rectangular shape. The wicking element 24 is arranged parallel to the heating element 22. Liquid aerosol-forming substrate is wicked into the wicking element 24 from the liquid storage portion 18 of the aerosol-generating device 10. The wicking element 24 is fluidly connected with the liquid aerosol-forming substrate in the liquid storage portion 18.

Liquid aerosol-forming substrate vaporized by the heating element 22 is entrained by ambient air being drawn through the airflow channel towards the mouthpiece 20.

Connected in series with the heating element 22, a connection strip 26 is arranged.

The connection strip 26 is a bimetal strip. The connection strip 26 is configured to prevent overheating of the heating assembly 14 by automatically disconnecting the electrical connection of the heating assembly 14 in case of an overheating scenario.

The connection strip 26 has an active layer and a passive layer. The active layer is arranged facing the wicking element 24. The passive layer is arranged facing away from the wicking element 24. The connection strip 26 is arranged freely spanning between a first solder spot 28 and a second solder spot 30.

The first solder spot 28 has a melting point of between 700° C. and 800° C. Therefore, the first solder spot 28 does not melt, even in an overheating scenario.

The second solder spot 30 has a melting point of around 250° C. The second solder spot 30 melts in an overheating scenario.

An overheating scenario particularly takes place if the liquid aerosol-forming substrate in the liquid storage portion 18 is depleted. Then, no liquid aerosol-forming substrate is delivered to the wicking element 24 anymore. The wicking element 24 thus becomes dry. A dry wicking element 24 may be heated over the normal operating temperature of between 200° C. and 240° C. if the heating element 22 is operated although the wicking element 26 is dry. To prevent undesired vapors be released from the wicking element 24, the overheating prevention is facilitated.

The overheating prevention is facilitated by the melting of the second solder spot 30 being configured as a soft solder spot. Additionally, the overheating prevention is facilitated by the bending action of the connection strip 26. In case of the temperature exceeding around 250° C., the second solder spot 30 melts. Thus, the connection strip 26 is no longer mechanically or electrically attached to the second solder spot 30. The connection strip 26 bends away from the second solder spot 30 and away from the wicking element 24. The releasing of the connection strip 26 due to the melting of the second solder spot 30 together with the bending away of the connection strip 26 leads to an electrical disconnection of the connection strip 26. Since the heating element 22 is connected in series with the connection strip 26, also the heating element 22 is no longer supplied with electrical energy. Heating stops.

Overheating prevention is achieved.

The heating element 22 is electrically connected with the second solder spot 30 by a second electrical contact pad 32. The second electrical contact pad 32 is arranged directly on the wicking element 24. The second solder spot 30 is in direct contact with the second electrical contact pad 32. The connection strip 26 is not in contact with the second electrical contact pad 32, but only in contact with the second solder spot 30. Thus, in an overheating scenario, the connection strip 26 is released while the heating element 22 remains unchanged.

The first solder spot 28 is arranged on a first electrical contact pad 34. The first electrical contact pad 34 is in direct contact with the wicking element 24. The first solder spot 28 is in direct contact with the first electrical contact pad 34. The first solder spot 28 is in electrical contact with the power supply of the main body 12 with an electrical connection 40. The heating element 22 is arranged between the second electrical contact pad 32 and a third electrical contact pad 36. A third solder spot 38 is in direct contact with the third electrical contact pad 36. The third electrical contact pad 36 is in direct contact with the wicking element 24. The third solder spot 38 is electrically connected with the power supply of the main body 12 with an electrical connection 42.

FIG. 3 shows a sectional view of the heating assembly 14 along the line A-A as shown in FIG. 2. FIG. 3 shows the arrangement of the connection strip 26 during the normal operation of the heating assembly 14. The connection strip 26 is electrically connected with the first solder spot 28 and with the second solder spot 30. The connection strip 26 is arranged freely spanning between the first solder spot 28 and the second solder spot 30.

FIG. 4 shows a sectional view of the heating assembly 14 along the line A-A similar to FIG. 3. In contrast to FIG. 3, an overheating scenario is shown in FIG. 4. Due to the temperature being higher than around 250° C., the second solder spot 30 melts. In addition to the melting of the second solder spot 30, the connection strip 26 is bending away from the second solder spot 30 and from the wicking element 24. Because of these two appearances, the connection strip 26 is no longer connected with the second solder spot 30 and the electric connection of the heating element 22 is interrupted. The heating thus stops. Overheating is prevented.

1.-15. (canceled)

16. A heating assembly for an aerosol-generating device, the heating assembly comprising:
a first solder spot;
a second solder spot; and
a connection strip electrically connecting the first solder spot with the second solder spot,
wherein one of the first solder spot and the second solder spot is configured as a soft solder spot with a melting temperature between 225° C. and 275° C., and
wherein the connection strip is configured as a bimetal strip.

17. The heating assembly according to claim 16, wherein the melting temperature of the soft solder spot is around 250′ C.

18. The heating assembly according to claim 16, wherein the connection strip is arranged freely spanning between the first solder spot and the second solder spot.

19. The heating assembly according to claim 16, wherein the connection strip is further configured to disconnect from the soft solder spot by bending away from the soft solder spot when a temperature of the connection strip exceeds 275° C.

20. The heating assembly according to claim 16, wherein the connection strip is further configured to disconnect from the soft solder spot by bending away from the soft solder spot when a temperature of the connection strip exceeds 250° C.

21. The heating assembly according to claim 16, wherein a melting temperature of the other of the first solder spot and the second solder spot, not being the soft solder spot, is between 600° C. and 900° C.

22. The heating assembly according to claim 16, wherein a melting temperature of the other of the first solder spot and the second solder spot, not being the soft solder spot, is between 700° C. and 800° C.

23. The heating assembly according to claim 16, wherein the bimetal strip comprises an active layer and a passive layer.

24. The heating assembly according to claim 16, wherein the bimetal strip comprises a layer of an alloy of Fe—Ni and a layer of one of Cu, Ni, Fe—Ni—Cr, Fe—Ni—Mn, and Mn—Ni—Cu.

25. The heating assembly according to claim 16, wherein the bimetal strip is configured to not change shape during a normal operating temperature of the heating assembly.

26. The heating assembly according to claim 16, wherein the normal operating temperature of the heating assembly is between 90° C. and 250° C.

27. The heating assembly according to claim 16, w % herein the normal operating temperature of the heating assembly is between 200° C. and 240° C.

28. The heating assembly according to claim 16, wherein the soft solder spot comprises one of Sn₉₅Pb₅, Pb, Pb₇₅In₂₅, and Pb₆₈Sn₃₂.

29. The heating assembly according to claim 16, wherein the other of the first solder spot and the second solder spot, not being the soft solder spot, comprises silver.

30. The heating assembly according to claim 16, wherein the other of the first solder spot and the second solder spot, not being the soft solder spot, consists of silver.

31. The heating assembly according to claim 16, wherein the soft solder spot is configured to melt and release the connection strip when a temperature of the soft solder spot exceeds 275° C.

32. The heating assembly according to claim 16, wherein the soft solder spot is configured to melt and release the connection strip when a temperature of the soft solder spot exceeds 250° C.

33. An aerosol-generating device comprising a heating assembly according to claim 16.

34. The aerosol-generating device according to claim 33, further comprising a liquid reservoir comprising liquid aerosol-forming substrate and a wicking element configured for wicking the liquid aerosol-forming substrate from the liquid reservoir to the heating assembly.

35. The aerosol-generating device according to claim 34, wherein one or more of the first solder spot is soldered by means of a first electrical contact pad, onto the wicking element, the second solder spot is soldered by means of a second electrical contact pad, onto the wicking element, and the third solder spot is soldered by means of a third electrical contact pad, onto the wicking element.
